(19) United States
(12) Patent Application Publication
(10) Pub. No.: US 2024/0276409 A1
(43) Pub. Date: Aug. 15, 2024

(54) METHODS AND SYSTEMS FOR TIMING SYNCHRONIZATION FOR DEVICE-TO-DEVICE POSITIONING

(71) Applicant: ZTE Corporation, Shenzhen (CN)

(72) Inventors: Juan LIU, Shenzhen (CN); Chuangxin JIANG, Shenzhen (CN); Mengzhen LI, Shenzhen (CN); Junpeng LOU, Shenzhen (CN); Qi YANG, Shenzhen (CN)

(21) Appl. No.: 18/643,167

(22) Filed: Apr. 23, 2024

Related U.S. Application Data
(63) Continuation of application No. PCT/CN2022/085679, filed on Apr. 8, 2022.

(51) Int. Cl. H04W 56/00

(52) U.S. Cl. CPC H04W 56/001

(57) ABSTRACT

Methods and systems for techniques for timing synchronization for device-to-device positioning are disclosed. In an implementation, a method of wireless communication includes communicating, by a first communication device, one or more timing synchronization parameters between the first communication device and a second communication device.

### CROSS REFERENCE TO RELATED APPLICATIONS

This patent document is a continuation of and claims benefit of priority to International Patent Application No. PCT/CN2022/085679, filed on Apr. 8, 2022. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meet the needs of various communication scenarios. Various techniques, including new ways to provide higher quality of service, longer battery life, and improved performance are being discussed.

### SUMMARY

This patent document describes, among other things, techniques mainly for timing synchronization for device-to-device positioning.

In one aspect, a method of data or positioning communication is disclosed. The method includes communicating, by a first communication device, one or more synchronization parameters between the first communication device and a second communication device.

In another aspect, a method of data or positioning communication is disclosed. The method includes providing, by a first communication device, a time information indicating at least one of time difference or synchronization between a second communication device and a set of neighboring communication devices.

In another aspect, a method of data or positioning communication is disclosed. The method includes communicating, by a first communication device, with a second communication device, a first time information indicating at least one of time difference or synchronization between a third communication device and a fourth communication device, communicating, by the first communication device, with the second communication device, a second time information indicating at least one of time difference or synchronization between the first communication device and the second communication device, or communicating, by the first communication device, with the second communication device, a third time information indicating at least one of time difference or synchronization between the first communication device and the third communication device.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of a timing relationship between uplink and downlink transmissions.

FIG. 4 shows an example of a timing advance command medium access control (MAC) control element (MAC CE).

FIG. 5A shows an example of a synchronization information transmission for NR sidelink communication, in an in-coverage (full or partial) scenario. FIG. 5B shows an example of a synchronization information transmission for NR sidelink communication, in an out of coverage scenario.

FIG. 6A shows an example of a synchronization information transmission for vehicle-to-everything (V2X) sidelink communication, in an in-coverage (full or partial) scenario. FIG. 6B shows an example of a synchronization information transmission for V2X sidelink communication, in an out of coverage scenario.

FIG. 7 shows an example of a process for wireless communication based on some example embodiments of the disclosed technology.

FIG. 8 shows another example of a process for wireless communication based on some example embodiments of the disclosed technology.

FIGS. 9A-9C show other examples of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

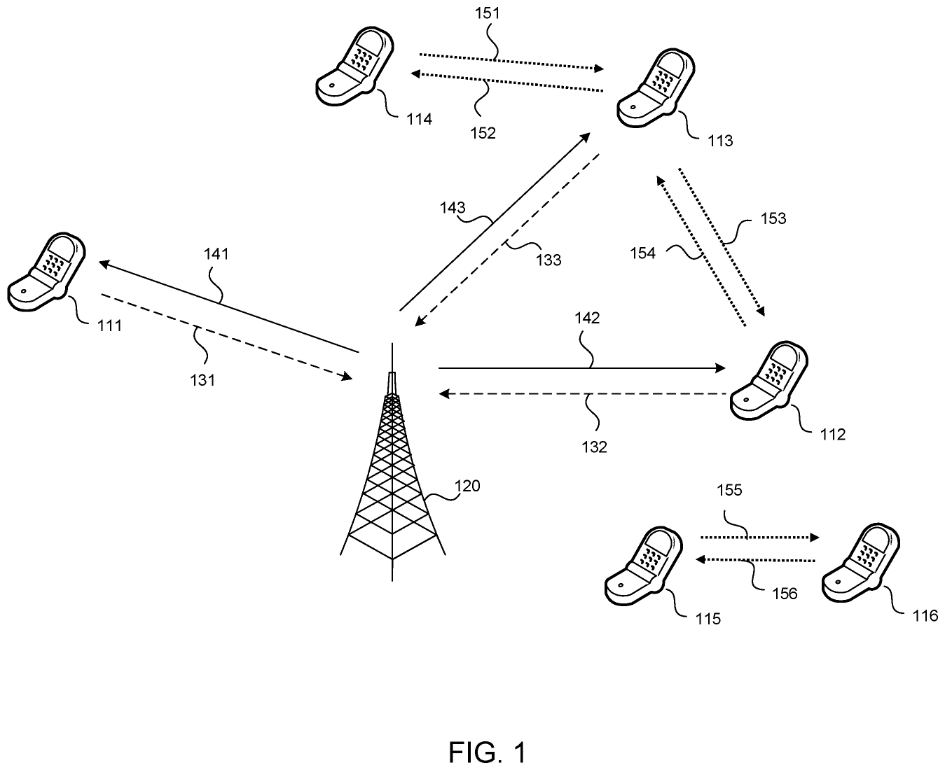

FIG. 1 shows an example of a wireless communication system (e.g., a long term evolution (LTE), 5G or NR cellular network) that includes a BS 120 and one or more user equipment (UE) 111, 112, 113, and 114. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. In some embodiments, UE (e.g., 112, 113, 114, 115, 116) can connect directly to another UE (e.g., 112, 113, 114, 115, 116) using device-to-device or sidelink communications (151, 152, 153, 154, 155, 156) without relaying their data via the BS 120. The UE may be, for example, a smartphone, a tablet, a mobile computer, a machine to machine (M2M) device, a terminal, a mobile device, an Internet of Things (IoT) device, and so on.

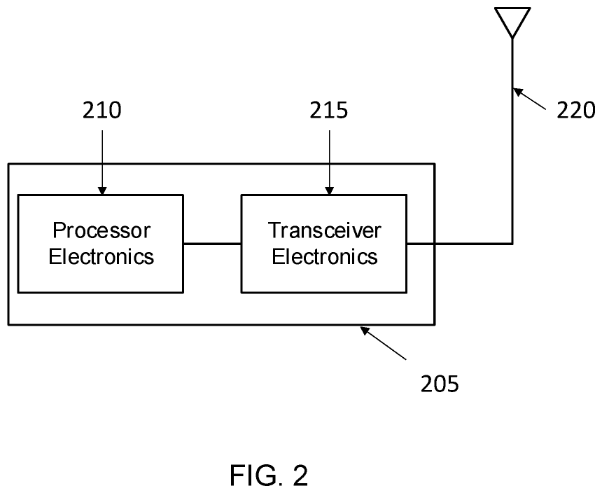

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

The fifth generation (5G) mobile networks with enhanced connectivity play an increasingly important role in the development of positioning techniques such as device-to-device positioning techniques. Many studies are being carried out to improve the accuracy of the positioning techniques. 3GPP Rel-18 study items are as below.

TABLE 1
RAN#94 for Rel-18 positioning

• Study and evaluate performance and feasibility of potential solutions for SL positioning,
considering relative positioning, ranging and absolute positioning: [RAN1, RAN2]

| | |
|---|---|
| - | Evaluate bandwidth requirement needed to meet the identified accuracy requirements |
| | [RAN1] |
| - | Study of positioning methods (e.g., TDOA, RTT, AOA/D, etc.) including combination |
| | of SL positioning measurements with other RAT dependent positioning measurements |
| | (e.g., Uu based measurements) [RAN1] |
| - | Study of sidelink reference signals for positioning purposes from physical layer |
| | perspective, including signal design, resource allocation, measurements, associated |
| | procedures, etc., reusing existing reference signals, procedures, etc. from sidelink |
| | communication and from positioning as much as possible [RAN1] |
| - | Study of positioning architecture and signaling procedures (e.g., configuration, |
| | measurement reporting, etc.) to enable sidelink positioning covering both UE based |
| | and network based positioning [RAN2, including coordination and alignment with |
| | RAN3 and SA2 as required] |

Note: When the bandwidth requirements have been determined and the study of sidelink
communication in unlicensed spectrum has progressed, it can be reviewed whether unlicensed
spectrum can be considered in further work. Checkpoint at RAN#97 to see if sufficient
information is available for this review.

In Table 1 above, “AoA” stands for Angle of Arrival, “TDoA” stands for Time Difference of Arrival, and “RTT” stands for multi-round trip time.

For the positioning method of TDOA before releases, the timing synchronization information between a reference Transmission and Reception Point (TRP) and neighboring TRPs is provided by Location Management Function (LMF), and thus a positioning UL knows the timing synchronization of each TRP.

### NR-RTD-INFO

The field “nr-RTD-Info” (37.355) provides the timing synchronization information between the reference TRP and neighboring TRPs.

The IE NR-RTD-Info is used by a location server to provide timing synchronization information between a reference TRP and a list of neighboring TRPs.

TABLE 2
nr-RTD-Info

-- ASN1START
NR-RTD-Info-r16 ::= SEQUENCE {

| | |
|---|---|
| referenceTRP-RTD-Info-r16 | ReferenceTRP-RTD-Info-r16, |
| rtd-InfoList-r16 | RTD-InfoList-r16, |

...
}
ReferenceTRP-RTD-Info-r16 ::= SEQUENCE {

| dl-PRS-ID-Ref-r16 | INTEGER (0..255), | |
|---|---|---|
| nr-PhysCellID-Ref-r16 | NR-PhysCellID-r16 | OPTIONAL, -- Need ON |
| nr-CellGlobalID-Ref-r16 | NCGI-r15 | OPTIONAL, -- Need ON |
| nr-ARFCN-Ref-r16 | ARFCN-ValueNR-r15 | OPTIONAL, -- Need ON |

| | |
|---|---|
| refTime-r16 | CHOICE { |
| systemFrameNumber-r16 | BIT STRING (SIZE (10)), |
| utc-r16 | UTCTime, |

```
    ...
  },
```

| | | |
|---|---|---|
| rtd-RefQuality-r16 | NR-TimingQuality-r16 | OPTIONAL, -- Need ON |

...
}
RTD-InfoList-r16 ::= SEQUENCE (SIZE (1..nrMaxFreqLayers-r16)) OF RTD-
InfoListPerFreqLayer-r16
RTD-InfoListPerFreqLayer-r16 ::= SEQUENCE (SIZE(1..nrMaxTRPsPerFreq-r16)) OF
RTD-InfoElement-r16
RTD-InfoElement-r16 :: = SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARFCN-ValueNR-r15 | OPTIONAL, -- Need ON |

| | |
|---|---|
| subframeOffset-r16 | INTEGER (0..1966079), |
| rtd-Quality-r16 | NR-TimingQuality-r16, |

...
}

In Table 2 above, “referenceTRP” stands for Reference TRP information of time synchronization, and “rtd-InfoList” stands for Neighboring TRPs' information of time synchronization.

### Example Embodiment 1: Information Request and Response

At least one of the following parameters may be communicated between two communication devices (See 38.331):
(1) synchronization priority order (sl-SyncPriority);
(2) priority group (index);
(3) sidelink synchronization identity (SSID);
(4) global navigation satellite system (GNSS) is reliable or not;
(5) one or more parameters (e.g., sl-SyncRefMinHyst and/or sl-SyncRefDiffHyst), Hysteresis when evaluating a synchronization reference UE (e.g., SyncRef UE) using absolute or relative comparison;
(6) one or more SSB time domain pattern, e.g., sl-SSB-TimeAllocation1, sl-SSB-TimeAllocation2, sl-SSB-TimeAllocation3;
(7) a parameter (e.g., inCoverage) that is a boolean variable. The value TRUE indicates that the UE transmitting the MasterlnformationBlockSidelink is in network coverage, or UE selects GNSS timing as the synchronization reference source; and/or
(8) a parameter (e.g., sl-NbAsSync) that indicates whether the network can be selected as a synchronization reference directly/indirectly only, if the synchronization priority order is set to gnss. If this parameter is set to TRUE, the network is enabled to be selected as a synchronization reference directly/indirectly.

In some implementations, a method of wireless communication includes communicating the information discussed above, and the communicating may include at least one of the following operations: transmitting, receiving, broadcasting, unicasting, groupcasting, forwarding, requesting, responding, reporting or exchanging.

In some implementations, the communication device may include at least one of the following devices: user equipment (UE), network node, base station, local server, TRP or LMF, peer UEs, access and mobility management functions (AMF).

In some implementations, the communication device selects the same value for at least one of the following parameters: synchronization priority order, priority group (index); SSID; GNSS is reliable or not; one or more parameters (e.g., sl-SyncRefMinHyst and/or sl-SyncRefDiffHyst), hysteresis when evaluating a synchronisation reference UE (e.g., SyncRef UE) using absolute or relative comparison; one or more SSB time domain pattern (e.g., sl-SSB-TimeAllocation1; sl-SSB-TimeAllocation2; sl-SSB-TimeAllocation3); a parameter (e.g., inCoverage) that is a boolean variable, and the value true indicates that the UE transmitting the MasterlnformationBlockSidelink is in network coverage, or UE selects GNSS timing as the synchronization reference source; a parameter (e.g., sl-NbAsSync) that indicates whether the network can be selected as synchronization reference directly/indirectly only, if synchronization priority order is set to gnss. If this parameter is set to TRUE, the network is enabled to be selected as synchronization reference directly/indirectly.

In one example, the communication devices can be considered as a peer communication device, at least one peer communication device sends a positioning reference signal (PRS) to the positioning communication device.

### Example Embodiment 2: Set a Communication Device as a Time Synchronization Reference Communication Device

In some implementations, a list of communication devices can be created and maintained to indicate time, timing synchronization information or timing differences between the time synchronization reference communication device and the neighboring communication devices, the first communication devices in the list can be considered as a time synchronization reference communication device, the second to the last communication device can be considered as neighboring communication devices.

In some implementations, a first communication device is set as a time synchronization reference communication device.

In some implementations, a list of neighboring communication devices can be created and maintained to indicate time, timing synchronization information or timing differences between the first time synchronization reference communication device and the neighboring communication devices.

In some implementations, a second communication device provides the time or timing synchronization information between the first time synchronization reference communication device and the neighboring communication devices.

In some implementations, the positioning UE reports at least one of user equipment identifier (UE ID), resource ID, resource set ID, timing synchronization information between the first time synchronization reference communication device and the neighboring communication devices, the reference communication device and/or the neighboring communication devices to a third communication device to calculate the positioning of the communication device.

In some implementations, at least one of the following, a first time synchronization reference communication device, or the neighboring communication devices include their own location information or know their own locations.

In some implementations, at least one of the following, the time synchronization reference communication device, or the neighboring communication devices include their own location information or know their own locations.

### Example Embodiment 3: Time Difference from the Original

A first communication device communicating, with a second communication device, a time/timing difference or timing synchronization information between the first communication device and a third communication device.

In some implementations, a first communication device communicating, with a second communication device, a time/timing difference or timing synchronization information between the third communication device and a fourth communication device.

In some implementations, a first communication device communicating, with a second communication device, a time/timing difference or timing synchronization information between the first communication device and a second communication device.

In some implementations, all the communication devices with the GNSS, eNB, gNB or SSID.

In some implementations, the communicating includes at least one of the following operations: transmitting, receiving, broadcasting, unicasting, groupcasting, forwarding, requesting, responding, reporting or exchanging.

In some implementations, the communication device includes one of the following devices: a user equipment (UE), a network node, a base station, a local server, a TRP or a Location Management Function (LMF), peer UEs, access and mobility management functions (AMF), or a global navigation satellite system (GNSS).

In some implementations, the time/timing difference/gap can be indicated by at least one of: a starting (e.g., staring time), a step (e.g., time step), a value (e.g., time-related value) and/or an offset (e.g., time offset).

In some implementations, examples of the step may include: {2, 4, 8, 16, 32, 64, 128}*Q Tc, where Tc is T_{c}=1/(Δfₘₐₓ·N_{f}) where Δfₘₐₓ=480·10³ Hz and N_{f}=4096, Q is an integer.

In some implementations, examples of the step may include: {2, 4, 8, 16, 32, 64, 128}*Q/2^{μ} Tc, where Tc is T_{c}=1/(Δfₘₐₓ·N_{f}) where Δfₘₐₓ=480·10³ Hz and N_{f}=4096, Q is an integer.

TABLE 3
Supported transmission numerologies

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

In some implementations, at least one of the following mathematical functions may be used: a starting+a step*a value−an offset, a starting+a step*a value+an offset, a starting−a step*a value−an offset, a starting−a step*a value+an offset, a starting+a step*a value, a starting−a step*a value, a starting−an offset, a starting+an offset.

In some implementations, examples of the offset may include: a parameter from the first communication device; a parameter from the second communication device; a parameter from the third communication device, from an LMP or a base station

In some implementations, the parameters (e.g., a starting, a step, a value, and/or an offset) are signaled by using a control signaling.

In some implementations, examples of the control signaling may include: radio resource control (RRC), MAC CE, downlink control information (DCI) or sidelink control information (SCI).

### Example Embodiment 4: New Sidelink SSB Time Allocation/Pattern (Sl-SSB-TimeAllocation) for Positioning

The disclosed technology can be implemented in some embodiments to use one or more sidelink SSB time allocation/pattern (e.g., sl-SSB-TimeAllocation) for positioning time/timing synchronization measurement purposes.

The first communication device may be configured by a second communication device with one or more sidelink SSB time allocation/pattern (e.g., sl-SSB-TimeAllocations).

In some implementations, a new sidelink SSB time allocation/pattern (e.g., sl-SSB-TimeAllocations) is defined or configured.

In some implementations, a second communication device transmits Sidelink Synchronization Signal/PBCH block (SL-SSB) using one or more sidelink SSB time allocation/pattern to a third UE.

In some implementations, one or more sidelink SSB time allocation/pattern (e.g., sl-SSB-TimeAllocations) can be preconfigured.

In some implementations, a communication device transmits the SL-SSB with one or more sidelink SSB time allocation/pattern (e.g., sl-SSB-TimeAllocations) by using the triggered signaling or be a predefined rule.

### Example Embodiment 5: New Sidelink SSB Time Allocation/Pattern (e.g., Sl-SSB-TimeAllocation) for Spectrum Sharing

In some implementations, one or more new sidelink SSB time allocation/pattern (e.g., sl-SSB-TimeAllocations) are defined or configured.

In some implementations, a first communication device transmits Sidelink Synchronization Signal/PBCH block (SL-SSB) using the new sidelink SSB time allocation/pattern to a second communication device.

In some implementations, the new sidelink SSB time allocation/pattern is used for the positioning UE.

In some implementations, the new sidelink SSB time allocation/pattern is used for peer communication information.

In some implementations, the new sidelink SSB time allocation/pattern is used for the positioning related communication device.

In some implementations, one or more time/timing synchronization parameters for new sidelink SSB time allocation/pattern can be communicated between communication devices.

In some implementations, the new sidelink SSB time allocation/pattern includes one of the following parameters: the number of sidelink SSB transmissions within one sidelink SSB period, the slot offset from the start of sidelink SSB period to the first sidelink SSB, or the slot interval between neighboring sidelink SSBs.

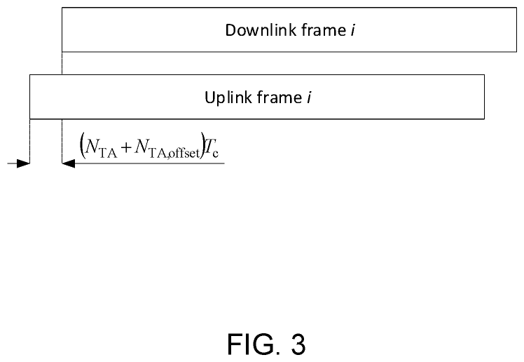

FIG. 3 shows an example of a timing relationship between uplink and downlink transmissions.

Uplink frame number i for transmission from the UE starts T_{TA}=(N_{TA}+N_{TA,offset}) T_{c} before the start of the corresponding downlink frame at the UE where N_{TA,offset} is given by the current standard (e.g., TS 38.213), except for msgA transmission on PUSCH where N_{TA}=0 is used.

### Timing Advance Command MAC CE

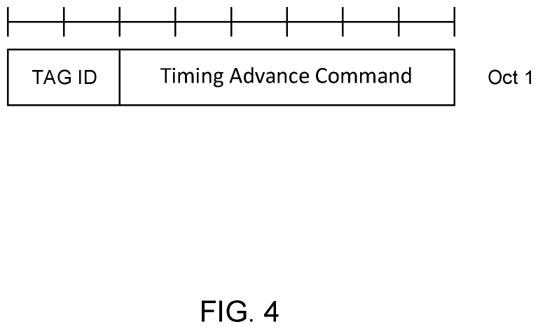

FIG. 4 shows an example of a timing advance command medium access control (MAC) control element (MAC CE).

Timing Advance Command MAC CE is identified by MAC subheader with logical channel identifier (LCID).

As shown in FIG. 4, the Timing Advance Command MAC CE has a fixed size and consists of a single octet defined as follows:
TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply (as specified in TS 38.213). The length of the field is 6 bits.

### Serving Cell Config Common

The IE ServingCellConfigCommon is used to configure cell specific parameters of a UEs serving cell. The parameter n-TimingAdvanceOffset is referred to as N_{TA,offset} in FIG. 3.

TABLE 4
ServingCellConfigCommon information element

-- ASN1START
-- TAG-SERVINGCELLCONFIGCOMMON-START

| | |
|---|---|
| ServingCellConfigCommon ::= | SEQUENCE { |

```
  physCellId
OPTIONAL, -- Cond HOAndServCellAdd,
  downlinkConfigCommon
OPTIONAL, -- Cond HOAndServCellAdd
  uplinkConfigCommon
OPTIONAL, -- Need M
```

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, |
| | n39936 } |

OPTIONAL, -- Need S

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}

### Sidelink Synchronization Information Transmission for New Radio (NR Sidelink Communication

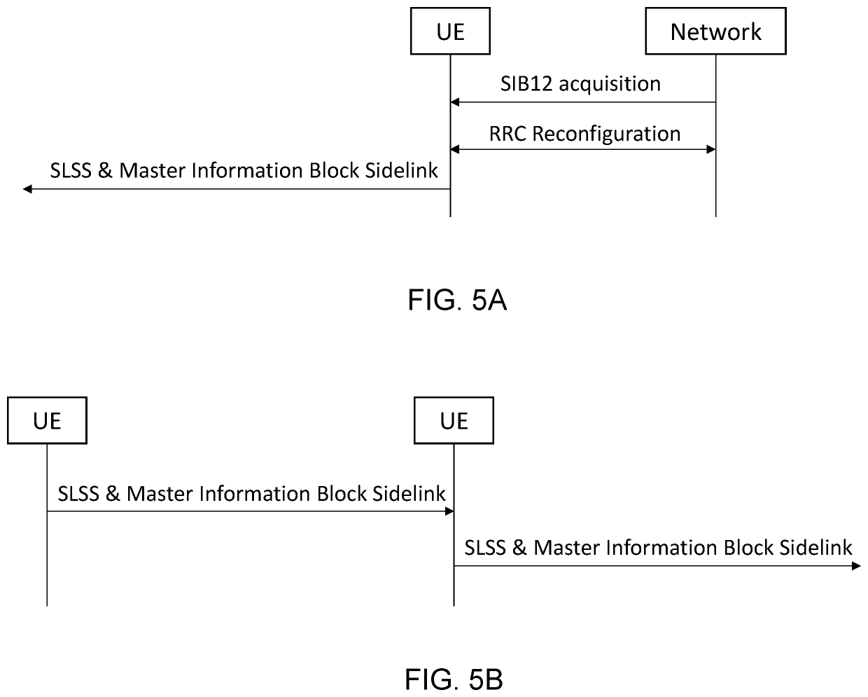

FIG. 5A shows an example of a synchronization information transmission for NR sidelink communication, in an in-coverage (full or partial) scenario. FIG. 5B shows an example of a synchronization information transmission for NR sidelink communication, in an out of coverage scenario. The purpose of this procedure is to provide synchronization information to a UE.

### Sidelink Synchronization Information Transmission for V2X Sidelink Communication

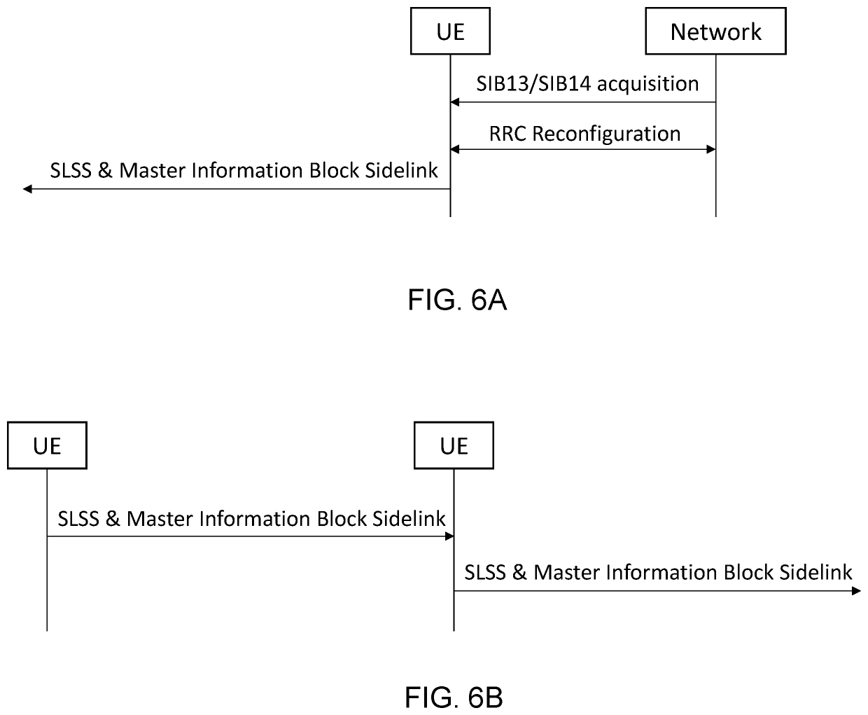

FIG. 6A shows an example of a synchronization information transmission for vehicle-to-everything (V2X) sidelink communication, in an in-coverage (full or partial) scenario. FIG. 6B shows an example of a synchronization information transmission for V2X sidelink communication, in an out of coverage scenario. The purpose of this procedure is to provide synchronization information to a UE.

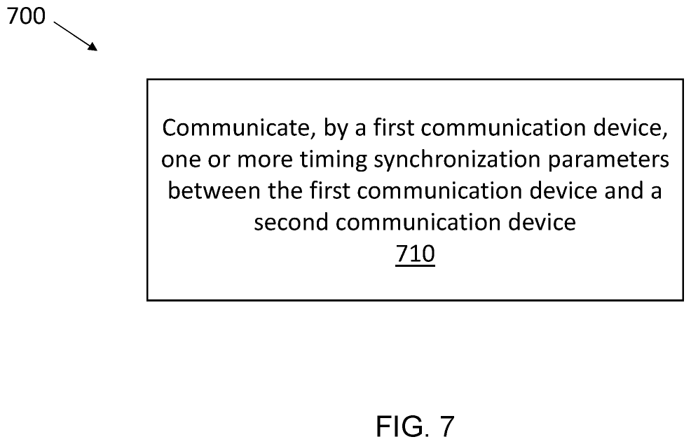

FIG. 7 shows an example of a process for wireless communication based on some example embodiments of the disclosed technology.

In some implementations, the process 700 for wireless communication may include, at 710, communicating, by a first communication device, one or more timing synchronization parameters between the first communication device and a second communication device.

In some implementations, the process 700 for wireless communication may further include determining, by the first communication device, a time/timing information indicating at least one of time/timing difference/gap or timing synchronization information in a communication between the first communication device and the second communication device based on the one or more timing synchronization parameters, and performing, by the first communication device, a device-to-device positioning operation based on the time/timing information.

In some implementations, the one or more timing synchronization (timing synchronization can be referred to as “synchronization”) parameters may include at least one of: a synchronization priority order; a priority group index; a sidelink synchronization identity (SSID); an indication as to whether a global navigation satellite system (GNSS) is reliable or not; whether GNSS is reliable in accordance with a method or a specification; a value associated with hysteresis when evaluating a time synchronization reference communication device using absolute comparison; a value associated with hysteresis when evaluating a time synchronization reference communication device using relative comparison; synchronization signal (SS) and physical broadcast channel (PBCH) block (SSB) time allocation/pattern; a time allocation/pattern of sidelink synchronization signal and PBCH block (SSB) transmissions; a time allocation/pattern of sidelink synchronization signal and PBCH block (SSB) transmissions for direct synchronization to GNSS; synchronization signal (SS) and physical broadcast channel (PBCH) block (SSB) time allocation/pattern for direct synchronization to GNSS, a value included in a master information block sidelink message to indicate that a communication device transmitting the master information block sidelink message is in a network coverage; a value indicating that a communication device selects GNSS timing as a synchronization reference source; or a field that indicates whether the network is allowed to be selected as a synchronization reference.

In some implementations, the communicating includes at least one of transmitting, receiving, broadcasting, unicasting, groupcasting, forwarding, requesting, responding, reporting or exchanging.

In some implementations, the first and second communication devices include at least one of: user equipment (UE), a network node, a local server, a transmission and reception point (TRP), a location management function (LMF), a peer communication device, an access and mobility management function (AMF), a global navigation satellite system (GNSS), or a base station.

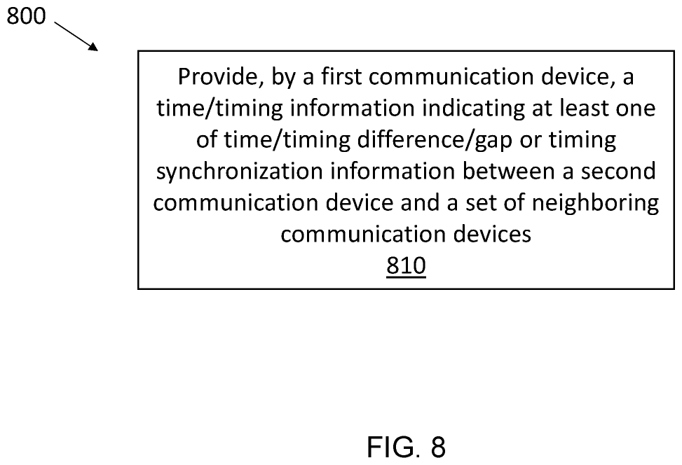

FIG. 8 shows another example of a process for wireless communication based on some example embodiments of the disclosed technology.

In some implementations, the process 800 for wireless communication may include, at 810, providing, by a first communication device, a time/timing information indicating at least one of time/timing difference/gap or timing synchronization information between a second communication device and a set of neighboring communication devices.

In some implementations, the process 800 for wireless communication may further include performing, by the first communication device, a device-to-device positioning operation based on the time/timing information.

In some implementations, the time/timing difference/gap includes at least one of a difference in a starting timing, a duration in time domain, or an offset in time domain.

In some implementations, the first and second communication devices include at least one of: user equipment (UE), a network node, a local server, a transmission and reception point (TRP), a location management function (LMF), a peer communication device, an access and mobility management function (AMF), a global navigation satellite system (GNSS), or a base station.

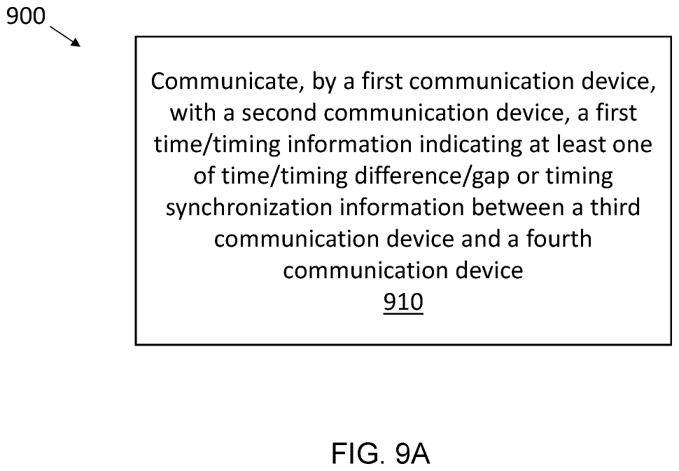

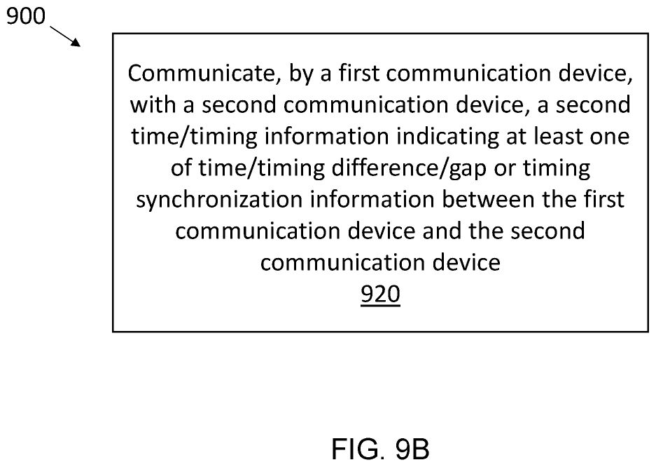

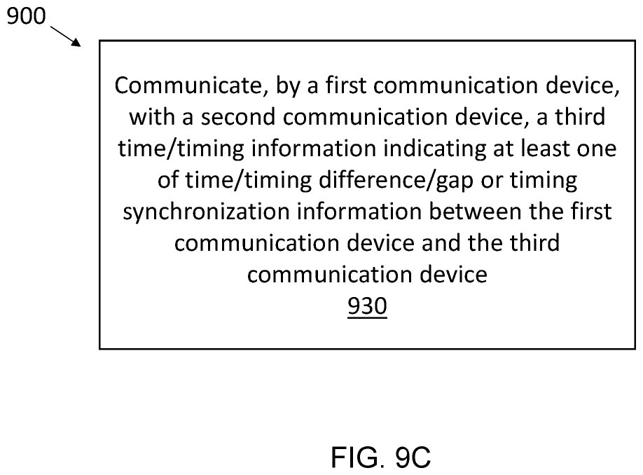

FIGS. 9A-9C show other examples of a process for wireless communication based on some example embodiments of the disclosed technology.

In some implementations, the process 900 for wireless communication may include, at 910, communicating, by a first communication device, with a second communication device, a first time/timing information indicating at least one of time/timing difference/gap or timing synchronization information between a third communication device and a fourth communication device, or at 920, communicating, by the first communication device, with the second communication device, a second time/timing information indicating at least one of time/timing difference/gap or timing synchronization information between the first communication device and the second communication device, or at 930, communicating, by the first communication device, with the second communication device, a third time/timing information indicating at least one of time/timing difference/gap or timing synchronization information between the first communication device and the third communication device.

In some implementations, the communication devices include information associated with at least one of: user equipment (UE), a network node, a local server, a transmission and reception point (TRP), a location management function (LMF), a peer communication device, an access and mobility management function (AMF), a global navigation satellite system (GNSS), a base station, or a sidelink synchronization identity (SSID).

In some implementations, the communication devices include at least one of: user equipment (UE), a network node, a local server, a transmission and reception point (TRP), a location management function (LMF), a peer communication device, an access and mobility management function (AMF), a global navigation satellite system (GNSS), or a base station.

In some implementations, the communicating includes at least one of transmitting, receiving, broadcasting, unicasting, groupcasting, forwarding, requesting, responding, reporting or exchanging.

In some implementations, the peer communication device is a communication device that is located nearby the positioning communication device.

In some implementations, the peer communication device is a communication device that satisfies one or more rules or one or more predefined rules.

In some implementations, the peer communication device is a communication device that satisfies one or more rules or one or more predefined rules related to the positioning communication device.

In some implementations, the time/timing difference/gap includes at least one of a difference in a starting timing, a duration in time domain, or an offset in time domain.

It will be appreciated that the present document discloses techniques that can be embodied in various embodiments to transmit and/or receive one or more timing synchronization parameters between different communication devices in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: communicating, by a first communication device, one or more timing synchronization parameters between the first communication device and a second communication device.

In some implementations, the one or more timing synchronization parameters may include at least one of: a priority group index; a sidelink synchronization identity (SSID); an indication as to whether a global navigation satellite system (GNSS) is reliable or not; whether GNSS is reliable in accordance with a method or a specification; a value associated with hysteresis when evaluating a time synchronization reference communication device using absolute comparison; a value associated with hysteresis when evaluating a time synchronization reference communication device using relative comparison; synchronization signal (SS) and physical broadcast channel (PBCH) block (SSB) time allocation/pattern; a time allocation/pattern of sidelink synchronization signal and PBCH block (SSB) transmissions; a time allocation/pattern of sidelink synchronization signal and PBCH block (SSB) transmissions for direct synchronization to GNSS; synchronization signal (SS) and physical broadcast channel (PBCH) block (SSB) time allocation/pattern for direct synchronization to GNSS, a value included in a master information block sidelink message to indicate that a communication device transmitting the master information block sidelink message is in a network coverage; a value indicating that a communication device selects GNSS timing as a synchronization reference source; or a field that indicates whether the network is allowed to be selected as a synchronization reference.

Clause 2. The method of clause 1, further comprising: determining, by the first communication device, a time/timing information that includes at least one of time/timing difference/gap or timing synchronization information in a communication between the first communication device and the second communication device based on the one or more timing synchronization parameters; and performing, by the first communication device, a device-to-device positioning operation based on the time/timing information.

Clause 3. The method of clause 1, wherein the one or more synchronization parameter(s) include at least one of: a synchronization priority order; a priority group index; a sidelink synchronization identity (SSID); an indication as to whether a global navigation satellite system (GNSS) is reliable or not; whether GNSS is reliable in accordance with a method or a specification; a value associated with hysteresis when evaluating a time synchronization reference communication device using absolute comparison; a value associated with hysteresis when evaluating a time synchronization reference communication device using relative comparison; synchronization signal (SS) and physical broadcast channel (PBCH) block (SSB) time allocation/pattern; a time allocation/pattern of sidelink synchronization signal and PBCH block (SSB) transmissions; a time allocation/pattern of sidelink synchronization signal and PBCH block (SSB) transmissions for direct synchronization to GNSS; synchronization signal (SS) and physical broadcast channel (PBCH) block (SSB) time allocation/pattern for direct synchronization to GNSS, a value included in a master information block sidelink message to indicate that a communication device transmitting the master information block sidelink message is in a network coverage; a value indicating that a communication device selects GNSS timing as a synchronization reference source; or a field that indicates whether the network is allowed to be selected as a synchronization reference.

Clause 4. The method of clause 1, wherein the communicating includes at least one of transmitting, receiving, broadcasting, unicasting, groupcasting, forwarding, requesting, responding, reporting or exchanging.

Clause 5. The method of clause 1, wherein the first and second communication devices include at least one of: user equipment (UE), network node, base station, local server, transmission and reception point (TRP), location management function (LMF), peer communication devices, or access and mobility management function (AMF).

Clause 6. The method of clause 1, wherein the first communication device and the second communication device are peer communication devices for a sidelink communication in a case that at least one of the timing synchronization parameters has a same value for both the first communication device and the second communication device.

Clause 7. The method of clause 6, wherein the peer communication devices transmit a positioning reference signal to a positioning communication device.

Clause 8. A method of wireless communication, comprising: providing, by a first communication device, a time/timing information indicating at least one of time/timing difference/gap or synchronization between a second communication device and a set of neighboring communication devices.

Clause 9. The method of clause 8, further comprising: performing, by the first communication device, a device-to-device positioning operation based on the time/timing information.

Clause 10. The method of clause 8, wherein the second communication device is selected as a reference communication device.

Clause 11. The method of clause 8, further comprising selecting a third communication device to provide timing synchronization information between the second communication device and the neighboring communication devices from the set of neighboring communication devices.

Clause 12. The method of clause 8, further comprising: communicating, with a third communication device, a first information associated with the second communication device and the neighboring communication devices, wherein the first information includes at least one of: user equipment identifier, resource identifier, resource set identifier, coordinated universal time (UTC) and time/timing information indicating at least one of time/timing difference/gap or timing synchronization information between the second communication device and the neighboring communication devices, wherein the third communication device acquires positioning information of the communication devices based on the first information.

Clause 13. The method of clause 12, wherein the communicating of the first information is performed by at least one of: a positioning communication device, the first communication device, the second communication device, a third communication device capable of communicating with the positioning communication device.

Clause 14. The method of clause 8, wherein the second communication device and the neighboring communication devices include their own location information or know their own locations.

Clause 15. The method of clause 8, wherein at least two of the second communication device and the neighboring communication devices are synchronized with a third communication device.

Clause 16. The method of clause 15, wherein the communication devices include information associated with at least one of: user equipment (UE), a network node, a local server, a transmission and reception point (TRP), a location management function (LMF), a peer communication device, an access and mobility management function (AMF), a global navigation satellite system (GNSS), a base station, or a sidelink synchronization identity (SSID).

Clause 17. A method of wireless communication, comprising: communicating, by a first communication device, with a second communication device, a first time/timing information indicating at least one of time/timing difference/gap or timing synchronization information between a third communication device and a fourth communication device; communicating, by the first communication device, with the second communication device, a second time/timing information indicating at least one of time/timing difference/gap or timing synchronization information between the first communication device and the second communication device; or communicating, by the first communication device, with the second communication device, a third time/timing information indicating at least one of time/timing difference/gap or timing synchronization information between the first communication device and the third communication device.

Clause 18. The method of clause 17, wherein the communication devices include information associated with at least one of: user equipment (UE), a network node, a local server, a transmission and reception point (TRP), a location management function (LMF), a peer communication device, an access and mobility management function (AMF), a global navigation satellite system (GNSS), a base station, or a sidelink synchronization identity (SSID).

Clause 19. The method of clause 17, wherein the communicating includes at least one of transmitting, receiving, broadcasting, unicasting, groupcasting, forwarding, requesting, responding, reporting or exchanging.

Clause 20. The method of clauses 8, 15 or 17, wherein the communication devices include at least one of: user equipment (UE), network node, base station, local server, transmission and reception point (TRP), location management function (LMF), peer UEs, access and mobility management function (AMF), or a global navigation satellite system (GNSS).

Clause 21. The method of clauses 2, 8 or 17, wherein the at least one of time or timing difference, time or timing gap, or timing synchronization information uses one or more new SSB time allocations or patterns.

Clause 22. The method of clause 21, wherein the one or more new SSB time allocations or patterns comprise one or more parameters, wherein the one or more parameters include at least one of: a number of sidelink SSB transmissions within one sidelink SSB period; a slot offset from a start of sidelink SSB period to a first sidelink SSB; or a slot interval between neighboring sidelink SSBs.

Clause 23. The method of clause 17, wherein the time/timing difference/gap includes at least one of a difference in a starting timing, a duration in time domain, or an offset in time domain.

Clause 24. An apparatus for wireless communication comprising a processor that is configured to carry out the method of any of clauses 1 to 22.

Clause 25. A non-transitory computer readable medium having code stored thereon, the code when executed by a processor, causing the processor to implement a method recited in any of clauses 1 to 23.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. In some implementations, or additionally, the disclosed components or modules can be implemented as an Application Specific Integrated Circuit (ASIC) and/or as a Field Programmable Gate Array (FPGA) device. Some implementations may additionally include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
communicating, by a first communication device, with a second communication device, a first timing information indicating at least one of time or timing difference, or a timing synchronization information between a third communication device and a fourth communication device.

2. The method of claim 1, wherein the communicating includes at least one of transmitting or reporting.

3. The method of claim 1, wherein the communication devices include at least one of: a user equipment (UE), or a location management function (LMF).

4. A first communication device comprising one or more processors and a memory, wherein the one or more processors are configured to read code from the memory and cause the first communication device to perform:
communicating, by the first communication device, with a second communication device, a first timing information indicating at least one of time or timing difference, or a timing synchronization information between a third communication device and a fourth communication device.

5. The device of claim 4, wherein the communicating includes at least one of transmitting or reporting.

6. The device of claim 4, wherein the communication devices include at least one of: a user equipment (UE) or a location management function (LMF).

7. A non-transitory computer readable medium having code stored thereon that, when executed by a processor of a first communication device, causes the first communication device to perform:
communicating, by the first communication device, with a second communication device, a first timing information indicating at least one of time or timing difference, or a timing synchronization information between a third communication device and a fourth communication device.

8. The non-transitory computer readable medium of claim 7, wherein the communicating includes at least one of transmitting or reporting.

9. The non-transitory computer readable medium of claim 7, wherein the communication devices include at least one of: a user equipment (UE) or a transmission and reception point (TRP).
